(19) United States
(12) Patent Application Publication
(10) Pub. No.: US 2011/0242094 A1
(43) Pub. Date: Oct. 6, 2011

(54) STEREOSCOPIC IMAGE DISPLAY APPARATUS AND STEREOSCOPIC IMAGE DISPLAY METHOD

(76) Inventor: Kunihiko Kawahara, Hamura-shi (JP)

(21) Appl. No.: 12/961,348

(22) Filed: Dec. 6, 2010

(30) Foreign Application Priority Data
Mar. 31, 2010 (JP) JP 2010-083793

(51) Int. Cl. G06T 15/00

(52) U.S. Cl. 345/419

(57) ABSTRACT

According to one embodiment, a stereoscopic image display includes an input module, a luminance processing module, a display panel, a light source, and a control module. The input module takes in a first image signal and a second image signal which has a parallax with respect to the first image signal and whose luminance is lower than that of the first image signal. The control module controls the lighting time of the light source to make the length of lighting time of the light source longer than a predetermined length of time when the first image signal whose luminance has been decreased by the luminance processing module is displayed on the display panel, and to make the length of the lighting time shorter than the predetermined length of time when the second image signal whose luminance has been increased by the luminance processing module is displayed on the display panel.

### CROSS-REFERENCE TO RELATED APPLICATIONS

This application is based upon and claims the benefit of priority from Japanese Patent Application No. 2010-083793, filed Mar. 31, 2010; the entire contents of which are incorporated herein by reference.

### FIELD

Embodiments described herein relate generally to improvements in a stereoscopic image display apparatus and a stereoscopic image display method which display a stereoscopic image by applying illumination light from a backlight to, for example, a display panel.

### BACKGROUND

As is well known, the technique for causing the user to recognize a three-dimensional image on a flat image display screen is being developed. The technique is such that two types of images, right- and left-eye images, which have a parallax corresponding to the distance between the eyes are prepared and the user's right eye is caused to recognize the right-eye image and the user's left eye is caused to recognize the left-eye image, thereby enabling the user to view an image stereoscopically.

Specifically, the right- and left-eye images are displayed alternately on the same image display screen and stereoscopic eyeglasses the user wears are controlled so as to close the left-eye shutter of the eyeglasses when the right-eye image is being displayed and close the right-eye shutter of the eyeglasses when the left-eye image is being displayed, thereby causing the user to recognize a stereoscopic image.

In recent years, an image display apparatus which uses a liquid-crystal display panel to display an image has become popular. This type of image display apparatus forms an image based on an image signal on the display panel and displays the image on the display panel by causing illumination light from the backlight using a cold-cathode tube, such as a fluorescent tube or an electric-discharge lamp, as a light source to pass through the panel from behind.

In this situation, the technique for displaying a stereoscopic image on an image display apparatus with a display panel is currently under active development. However, the technique for displaying a stereoscopic image on a liquid-crystal display panel is still in a development stage and has plenty of room to improve in various respects for practical use.

Specifically, when the response characteristic of an output image of the display panel with respect to an input image signal is gradual, the influence of the output image of the immediately preceding frame remains in a frame to be currently displayed, with the result that the frame to be currently displayed and the immediately preceding frame might be displayed at the same time.

In this case, since images that have a parallax between them are displayed alternately in a stereoscopic system which displays a right- and a left-eye image alternately, the appearance of the immediately preceding frame is particularly conspicuous, which causes the display to look blurred to the user or so-called three-dimensional crosstalk to occur.

Jpn. Pat. Appln. KOKAI Publication No. 2001-258052 has disclosed a stereoscopic image display apparatus which extracts an area whose image level difference between a right- and a left-eye image signal is larger, suppresses the image level of an area whose image level is higher, and increases the image level of an area whose image level is lower, thereby alleviating crosstalk between the right- and left-eye image signals.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram to explain an example of the signal processing system of a stereoscopic image display apparatus according to an embodiment;

FIGS. 2A, 2B and 2C are diagrams to explain an example of the operation of an image signal processing module constituting the stereoscopic image display apparatus of the embodiment;

FIG. 3 is a plan view to explain an example of a liquid-crystal display panel constituting the stereoscopic image display apparatus of the embodiment;

FIG. 4 is a plan view to explain an example of a backlight constituting the stereoscopic image display module of the embodiment;

FIG. 5 is a side view to explain an example of the relationship between the liquid-crystal display panel and backlight constituting the stereoscopic image display module of the embodiment;

FIGS. 6A, 6B and 6C are diagrams to explain an example of the primary processing operation of the stereoscopic image display apparatus of the embodiment;

FIGS. 7A, 7B and 7C are diagrams to explain an example of the primary processing operation of the stereoscopic image display apparatus of the embodiment;

FIGS. 8A, 8B and 8C are diagrams to explain an example of the primary processing operation of the stereoscopic image display apparatus of the embodiment;

FIGS. 9A, 9B and 9C are diagrams to explain an example of the primary processing operation of the stereoscopic image display apparatus of the embodiment;

FIG. 10 is a flowchart to explain an example of the primary processing operation of the stereoscopic image display apparatus of the embodiment;

FIGS. 11A, 11B and 11C are diagrams to explain an example of the relationship between an image display on the liquid-crystal display panel and the lighting state of the backlight in the embodiment; and

FIGS. 12A, 12B and 12C are diagrams to explain an exemplified modification of the primary processing operation of the stereoscopic image display apparatus of the embodiment.

### DETAILED DESCRIPTION

Various embodiments will be described hereinafter with reference to the accompanying drawings. In general, according to one embodiment, a stereoscopic image display comprises an input module, a luminance processing module, a display panel, a light source, and a lighting time control module. The input module takes in a first image signal and a second image signal which has a parallax with respect to the first image signal and whose luminance is lower than that of the first image signal. The luminance processing module decreases the luminance of the first image signal and increases the luminance of the second image signal. The display panel displays the first image signal whose luminance has been decreased and the second image signal whose luminance has been increased. The light source applies light to the display panel. The lighting time control module controls the lighting time of the light source so as to make the length of time which the light source lights longer than a predetermined length of time when the first image signal whose luminance has been decreased is displayed on the display panel and make the length of time which the light source lights shorter than the predetermined length of time when the second image signal whose luminance has been increased is displayed on the display panel.

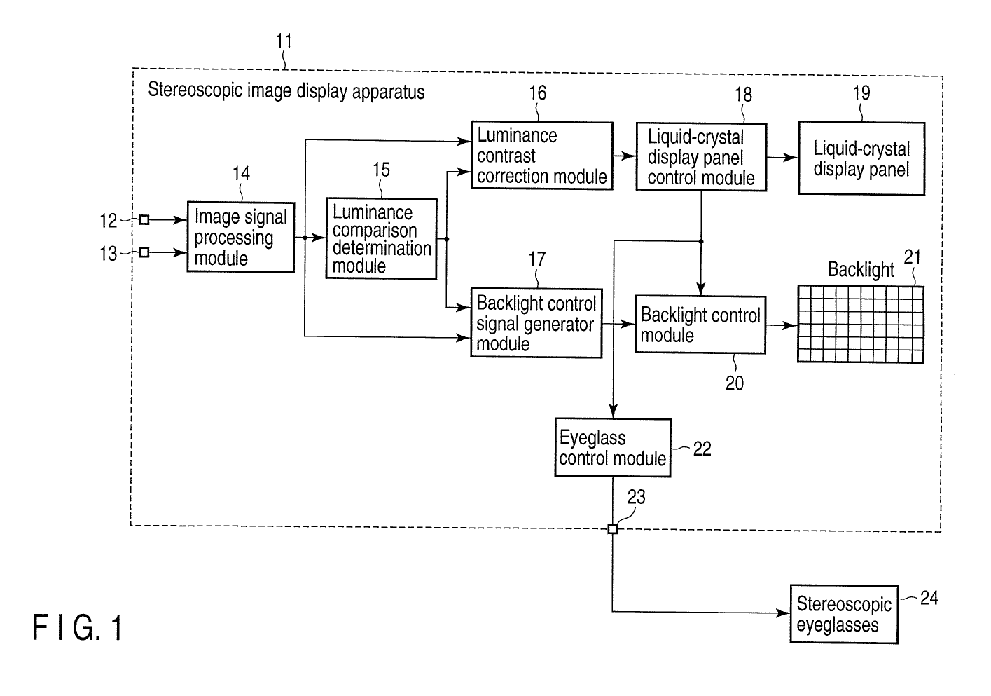

FIG. 1 shown the signal processing system of the stereoscopic image display apparatus 11 explained in the embodiment. The stereoscopic image display apparatus 11 has two input terminals 12, 13 to which two types of image signals which have a parallax corresponding to the distance between the eyes are supplied.

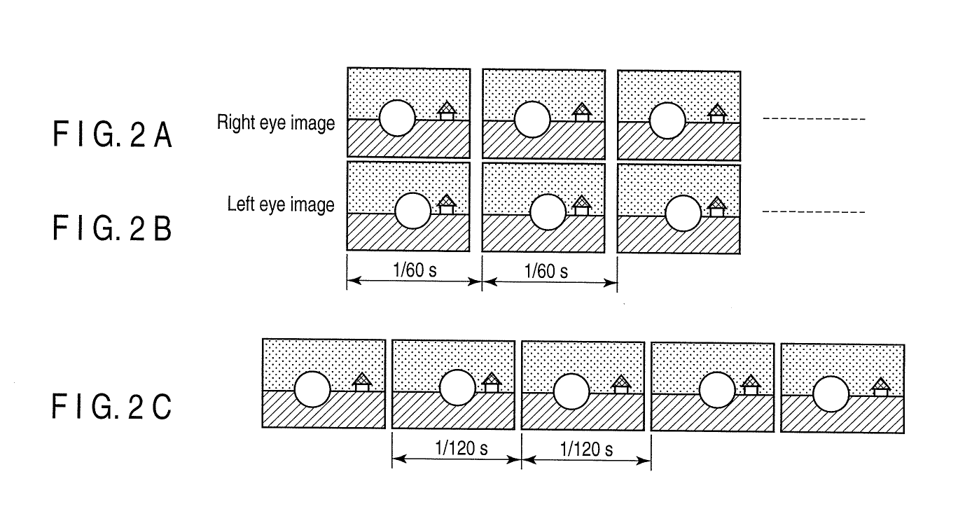

As shown in FIG. 2A, a right-eye image signal for forming a right-eye image with a frame period of 1/60 s is input to one input terminal 12. As shown in FIG. 2B, a left-eye image signal for forming a left-eye image with a frame period of 1/60 s is input to the other input terminal 13. While in the embodiment, the frame period of each image has been 1/60 s for illustrative purposes, the frame period is not limited to this. For instance, the frame period may be 1/120 s, 1/240 s, or the like.

The right- and left-eye image signals can be obtained by receiving, for example, stereoscopic image signals broadcast by broadcasting companies. Alternatively, they may be obtained from content distributors via a network or the like or by reproducing them from a recording medium, such as an optical disk.

The right and left image signals supplied to the input terminals 12, 13 are supplied to an image signal processing module 14. The image signal processing module 14 arranges the right- and left-eye image signals supplied to the input terminals 12, 13 alternately in frames so that the frame period may double or become 1/120 s as shown in FIG. 2C. As described above, the frame period is not restricted to 1/120 s.

Then, the image signal output from the image signal processing module 14 is supplied to a luminance comparison determination module 15, a luminance contrast correction module 16, and a backlight control signal generation module 17. The luminance comparison determination module 15 compares the image signals in two consecutive frames supplied from the image signal processing module 15 to determine the luminance difference between them.

The luminance contrast correction module 16, which will be explained later in detail, subjects the image signal supplied from the image signal processing module 14 to a correction process so as to decrease the luminance contrast ratio on the basis of the luminance difference determined by the luminance comparison module 15. Then, the image signal subjected to the correction process at the luminance contrast correction module 16 is supplied to the liquid-crystal display panel control module 18.

The liquid-crystal display panel control module 18 causes one frame of the image signal subjected to the correction process at the luminance contrast correction module 16 to be written into a plurality of pixels constituting the liquid-crystal display panel 19 in a subsequent stage, thereby forming one frame of display image on the liquid-crystal display panel 19.

The backlight control signal generation module 17, which will be described in detail later, generates a backlight control signal for performing lighting control of a plurality of light sources constituting a backlight 21 in a subsequent stage on the basis of the luminance difference determined by the luminance comparison determination module 15 and the luminance of the image signal supplied from the image signal processing module 14.

The backlight control signal generated by the backlight control signal generation module 17 is supplied to a backlight control module 20. The backlight control module 20 controls the lighting time of each of the light sources constituting the backlight 21 on the basis of the backlight control signal supplied from the backlight control signal generation module 17.

In this case, the liquid-crystal display panel control module 18 generates a frame synchronization signal for synchronizing the backlight 21 with each of the frames in displaying each frame and outputs the frame synchronization signal to the backlight control module 20. Then, the backlight control module 20 controls the lighting time of each of the light sources constituting the backlight 21 frame by frame on the basis of the backlight control signal.

In this way, an image is displayed using a so-called local dimming technique. The local dimming technique is such that the backlight 21 is composed of a plurality of light sources and the lighting time of each of the light sources is controlled according to light and dark parts of a display image in one frame of the display screen so as to make a dark part darker and a light part lighter on the same screen to increase contrast.

The frame synchronization signal generated at the liquid-crystal display panel control module 18 is supplied to an eyeglass control module 22. The eyeglass control module 22 generates a right-eye shutter control signal and a left-eye shutter control signal on the basis of the frame synchronization signal supplied from the liquid-crystal display panel control module 18 and outputs the shutter control signals via an output terminal 23 to stereoscopic eyeglasses 24 the user wears.

That is, the eyeglass control module 22 performs control so as to close the left-eye shutter of the stereoscopic eyeglasses 24 when a right-eye image is being displayed and close the right-eye shutter of the stereoscopic eyeglasses 22 when a left-eye image is being displayed, thereby causing the user to recognize a stereoscopic image.

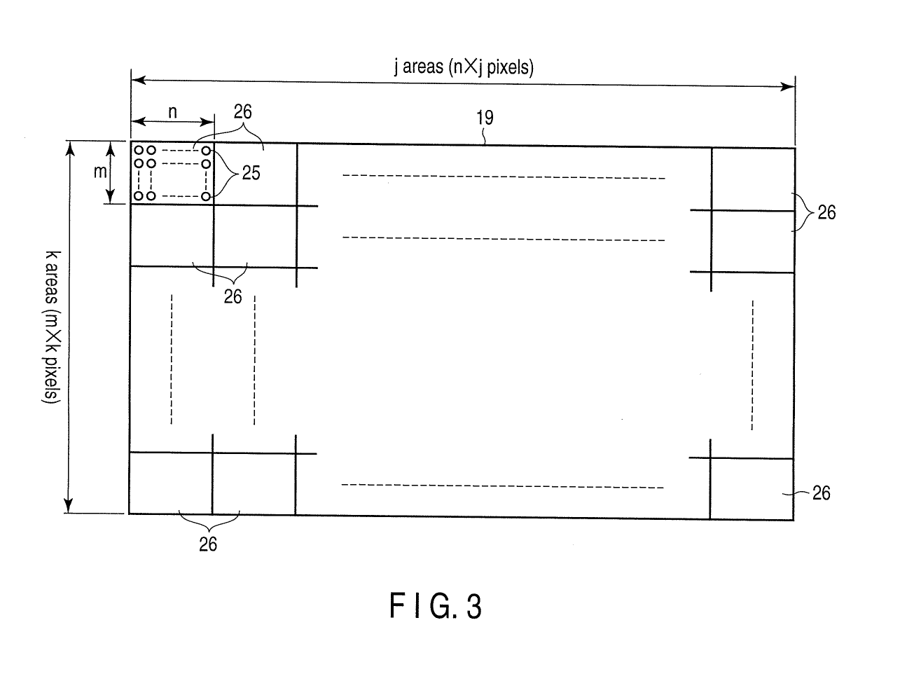

FIG. 3 shows an example of the liquid-crystal display panel 19. The liquid-crystal display panel 19 is configured to arrange a plurality of pixels 25 composed of liquid-crystal cells horizontally and vertically in a matrix. In this case, the panel surface of the liquid-crystal display panel 19 is divided into a plurality of (j×k) areas 26, with j areas in the horizontal direction and k areas in the vertical direction. Each of the areas 26 includes a plurality of (n×m) pixels 25, with n pixels in the horizontal direction and m pixels in the vertical direction.

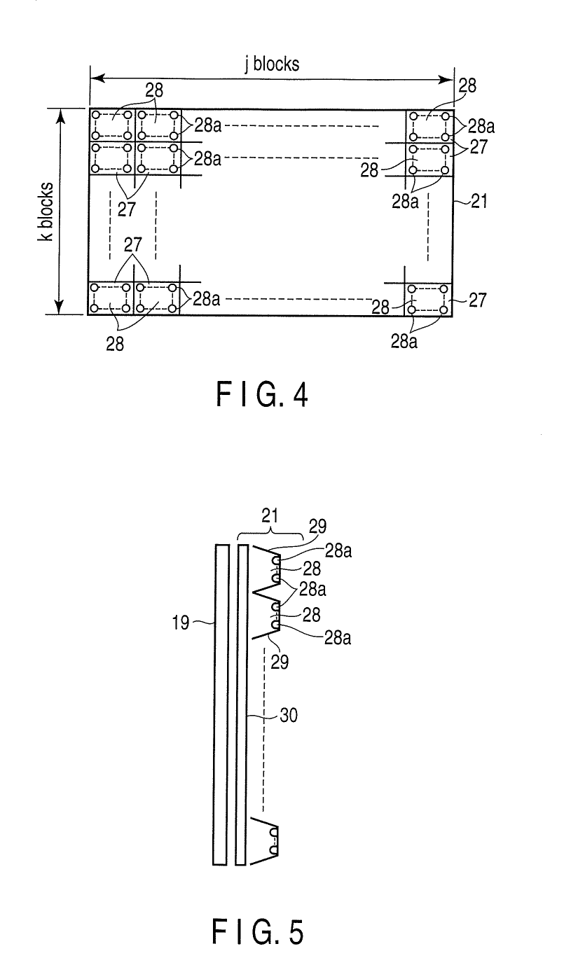

FIG. 4 shows an example of the backlight 21. The backlight 21 is configured to arrange a plurality of (j×k) blocks 27 in a matrix, with j blocks in the horizontal direction and k blocks in the vertical direction, the blocks 27 being caused to correspond to the areas 26 of the liquid-crystal display panel 19 respectively. Each of the blocks 27 is provided with a light source unit 28 composed of a plurality of light sources 28a, such as light-emitting diodes (LEDs).

More specifically, as shown in FIG. 5, the backlight 21 is such that a light source unit 28 composed of a plurality of light sources 28a, such as white LED arrays, is arranged in each of the blocks 27, each of the light source units 28 is covered with a reflecting plate 29, and a diffusion plate 30 is provided on the irradiated face of each reflecting plate 29 to apply light uniformly in blocks 27.

The backlight 21 is arranged on the back side of the liquid-crystal display panel 19 and applies light to the liquid-crystal display panel 19 from behind, thereby displaying an image. In this case, the backlight 21 can control the lighting time of each of the light source units 28 independently under the control of the backlight control module 20.

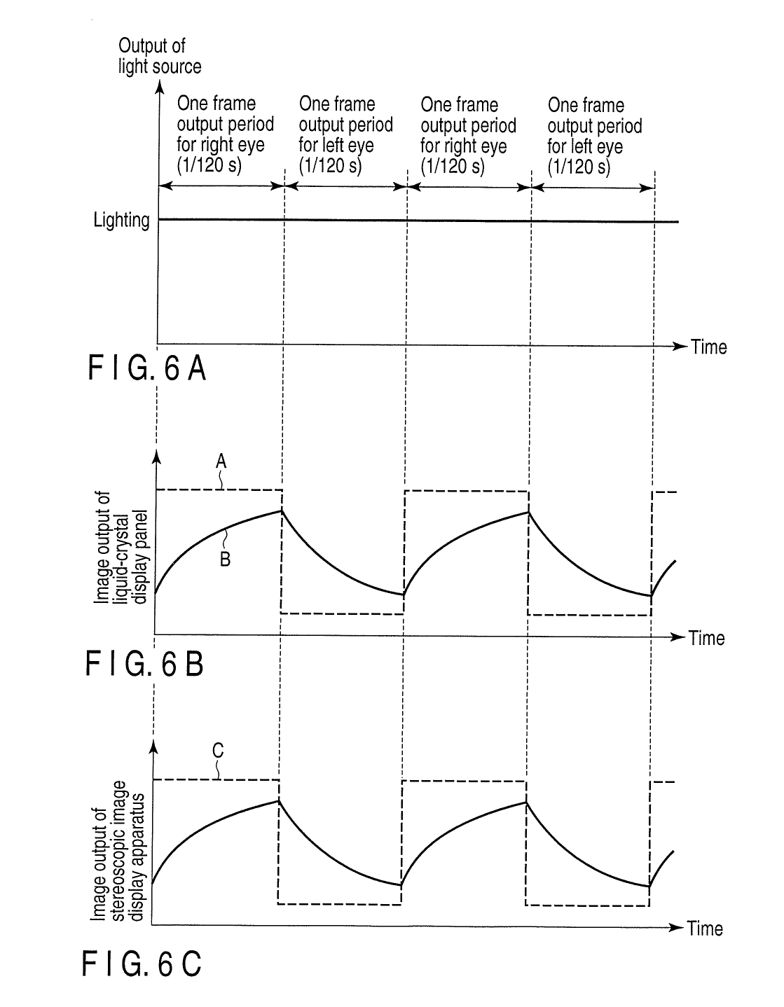

The operation of reducing three-dimensional crosstalk in a stereoscopic image at the stereoscopic image display apparatus 11 will be explained with reference to FIGS. 6A to 6C, 7A to 7C, 8A to 8C, and 9A to 9C.

First, FIG. 6A shows the turning-on time and turning-off time in each one frame display period of the light source unit 28 constituting the backlight 21. In FIG. 6A, the ordinate represents the amount of light output by the light source unit 28 that applies light to a specific pixel 25 of the liquid-crystal display panel control module 18 and the abscissa represents time. FIG. 6A shows a case where the light source unit 28 constantly lights during the output period of one frame.

FIG. 6B shows an image output (luminance response characteristic) with respect to an input image signal for each frame at the liquid-crystal display panel 19. In FIG. 6B, the ordinate represents the output of an image of a specific pixel 25 of the liquid-crystal display panel 19 and the abscissa represents time. In this embodiment, a case where the liquid-crystal display panel control module 18 is to output a right-eye image as an image signal with a specific value and a left-eye image signal with a specific output value lower than the value of the right-eye image signal will be explained for illustrative purposes. It is ideal if the image output (luminance response characteristic) of the liquid-crystal display panel 19 with respect to the input image signal presents a square waveform as shown by dotted line A in FIG. 6B. However, an actual image output (luminance response characteristic) might be influenced by a change from the image in the preceding frame and presents a gentler waveform than the ideal waveform as shown by solid line B in FIG. 6B.

Since the output image (display image) of the stereoscopic image display apparatus 11 is visible to the user during the time when the light source unit 28 of the backlight is lighting, the output image is displayed as an image whose luminance is lower than that of the ideal image output shown by dotted line C in the entire output period of each frame as shown by a solid line in FIG. 6C. FIG. 6C shows an output image (display image) when the stereoscopic image display apparatus 11 outputs an image so that the image may be visible to the user. In FIG. 6C, the ordinate represents an image visible to the user of the images displayed by a specific pixel 25 of the stereoscopic image display apparatus 11 and the abscissa represents time. In this case, the stereoscopic image display apparatus 11 outputs an image in such a manner that the image output onto the liquid-crystal display panel 19 of FIG. 6B is visible to the user during the time when the light source unit 28 of the backlight 21 in FIG. 6A is lighting. That is, the part shown by a solid line (thick line) of FIG. 6C where the period during which the light source unit 28 of the backlight 21 in FIG. 6A lights overlaps with the output image of the liquid-crystal display panel 19 in FIG. 6B is an output image (display image) visible to the user output by the stereoscopic image display apparatus 11. When the light source unit 28 constantly lights in the output period of one frame as shown in FIG. 6C, the influence of the output value of the immediately preceding frame remains seriously at the beginning of the output period of one frame and, in this period, considerable three-dimensional crosstalk occurs (or the image of the immediately preceding frame remains).

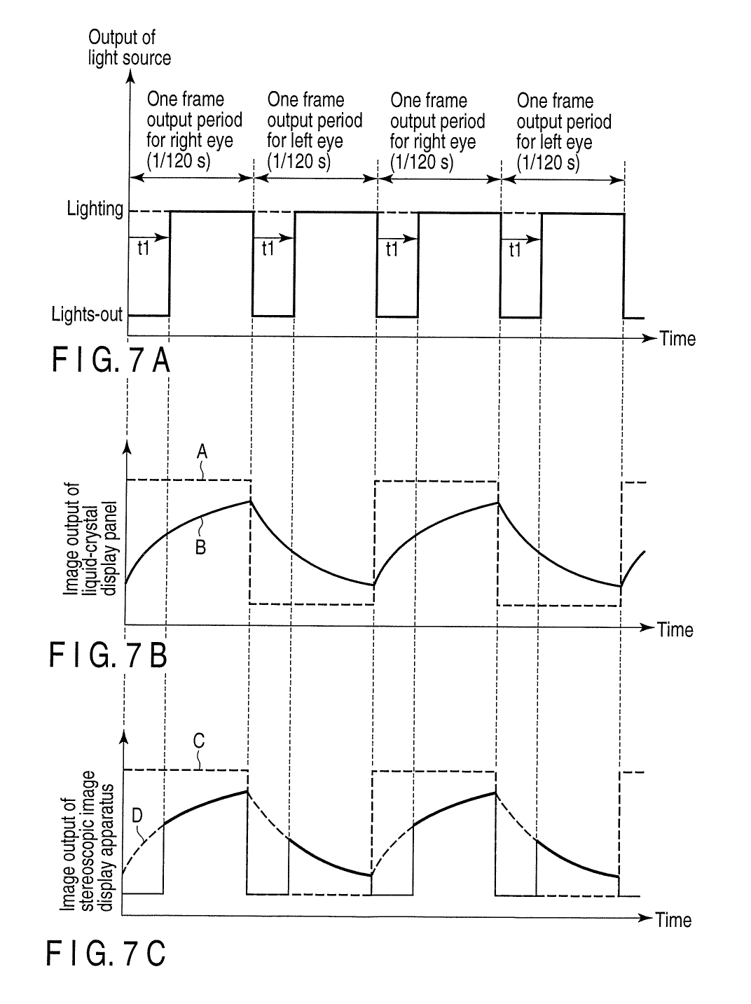

Therefore, as shown in FIG. 7A, in each frame output period, the light source unit 28 is turned off for a specific time t1 since the start time of a frame. When time t1 has elapsed, the light source unit 28 is turned on. In this case, an image output (luminance response characteristic) of the liquid-crystal display panel 19 with respect to an input image signal in each frame is as shown by solid line B in FIG. 7B, having the same characteristic as shown by solid line B in FIG. 6B.

However, the light source unit 28 has been off until time t1 has elapsed since the start time of each frame. Therefore, the image output of the stereoscopic image display apparatus 11 is as shown by a thick line in FIG. 7C. Specifically, the image output far from the ideal response characteristic of the liquid-crystal display panel 19 shown by dotted line C, that is, the image output at the beginning of one frame period shown by dotted line D where the influence of the image in the preceding frame remains significantly, is not displayed, which reduces three-dimensional crosstalk.

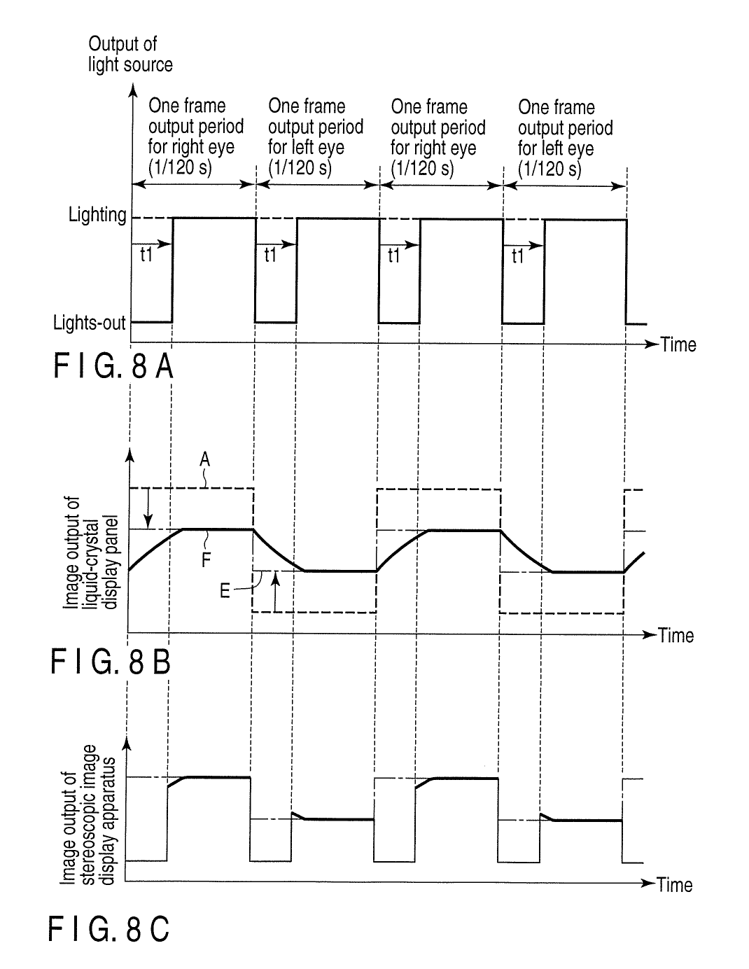

Next, as shown in FIG. 8A, in a state where the light source unit 28 is controlled so as to be turned off for a specific time t1 since the start time of each frame and to be turned on when time t1 has elapsed, the luminance contrast ratio of the image output of the liquid-crystal display panel 19 shown by dotted line A in FIG. 8B is decreased as shown by dot-dash line E.

That is, the luminance for the right-eye image signal is decreased and that for the left-eye image signal is increased. Specifically, if the contrast ratio of the luminance response characteristic shown by dotted line A is in the range from a lower limit of 0 to an upper limit of 256, the lower limit is increased to 100 and the upper limit is decreased to 200.

As described above, the difference in luminance between the luminance of the right-eye image and that of the left-eye image is decreased, which shortens the time demanded for the luminance of the right-eye image to reach the luminance of the left-eye image or for the luminance of the left-eye image to reach the luminance of the right-eye image in the image output of the liquid-crystal display panel 19 as shown by solid line F in FIG. 8B. Accordingly, in the image output of the stereoscopic image display apparatus 11, the influence of the luminance value of the immediately preceding frame in each frame output period decreases as shown by thick line in FIG. 8C, which reduces three-dimensional crosstalk more.

In the image output of the stereoscopic image display apparatus 11 shown in FIG. 8C, although three-dimensional crosstalk is reduced, the luminance contrast ratio decreases. Therefore, the lighting time of the light source unit 28 is controlled so as to make longer the lighting time of the light source unit 28 in a frame whose luminance is high and make shorter the lighting time of the light source unit 28 in a frame whose luminance is low.

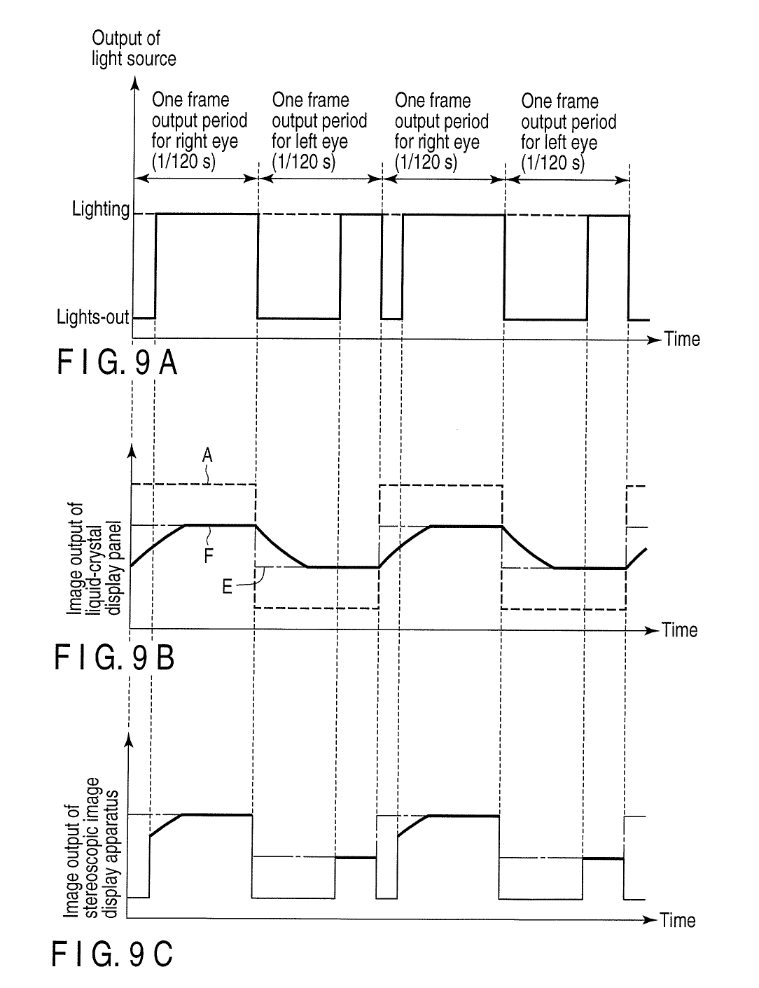

This makes the image output of the stereoscopic image display apparatus 11 as shown by a thick line in FIG. 9C even if the luminance contrast ratio of the image output of the liquid-crystal display panel 19 is limited as shown by solid line F in FIG. 9B. As a result, in a part where luminance is lower than that of the original output image, the light source unit 28 is kept on for a longer time and therefore the image is displayed more brightly. In a part where luminance is higher, the light source unit 28 is kept on for a shorter time and therefore the image is displayed darkly. By doing this, the stereoscopic image display apparatus 11 can display a good image with an improved luminance contrast ratio of consecutive images.

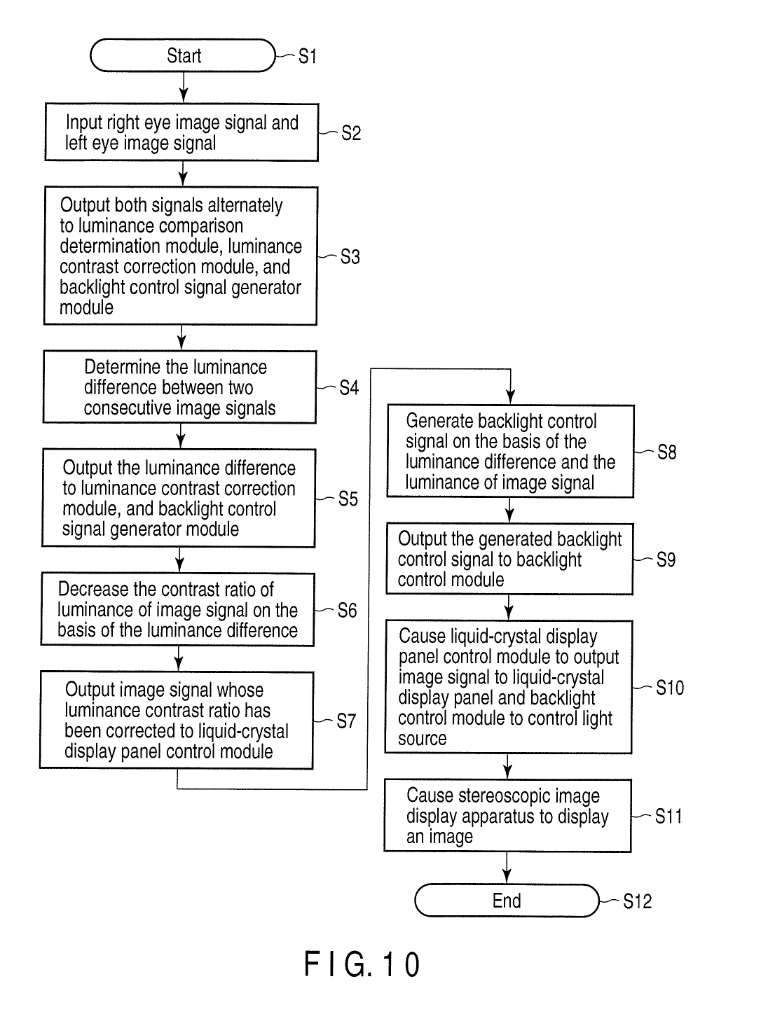

FIG. 10 is a flowchart to explain the operation of reducing three-dimensional crosstalk in a stereoscopic image at the stereoscopic image display apparatus 11. Specifically, when a process is started (step S1), the image signal processing module 14 takes in a right- and a left-eye image signal via the input terminals 12 and 13, respectively, in step S2. In step S3, the image signal processing module 14 arranges both image signals in frames alternately and outputs the resulting signal to the luminance comparison determination module 15, luminance contrast correction module 16, and backlight control signal generation module 17.

Then, in step S4, the luminance comparison determination module 15 compares two consecutive frames supplied from the image signal processing module 14, determines the luminance difference between them, and in step S5, outputs the determined luminance difference to the luminance contrast correction module 16 and backlight control signal generation module 17.

In step S6, the luminance contrast correction module 16 corrects an image signal supplied from the image signal processing module 14 so as to decrease the luminance contrast ratio on the basis of the luminance difference supplied from the luminance comparison determination module 15. That is, as explained in FIG. 8B, the luminance contrast ratio shown by dotted line A with respect to the image output of the liquid-crystal display panel 19 is decreased as shown by dot-dash line E. In step S7, the luminance contrast correction module 16 outputs the image signal whose luminance contrast ratio has been corrected to the liquid-crystal display panel control module 18.

In addition, on the basis of the luminance difference supplied from the luminance comparison determination module 15 and information on the luminance of the image signal supplied from the image signal processing module 14, the backlight control signal generation module 17 generates a backlight control signal for performing lighting control of the light source unit 28 so as to improve the decreased luminance contrast in step S8. The backlight control signal also includes information that turns off the light source unit 28 for a specific time t1 since the start time of each frame as explained in FIG. 7A. Then, in step S9, the backlight control signal generation module 17 outputs the generated backlight control signal to the backlight control module 20.

Thereafter, in step S10, the liquid-crystal display panel control module 18 outputs an image signal to the liquid-crystal display panel 19 and the backlight control module 20 controls the lighting time of the light source unit 28 on the basis of a backlight control signal. As a result, in step S11, the stereoscopic image display apparatus 11 displays an image that reduces three-dimensional crosstalk as shown in FIG. 9C and has a sufficient luminance contrast ratio, which completes the process (step S12).

In this case, even if the frame frequency of the right- and left-eye images for stereoscopic display and the response characteristic of the liquid-crystal display panel 19 with respect to n input image remain unchanged, three-dimensional crosstalk in a stereoscopic image can be reduced, while the deterioration of image quality is suppressed.

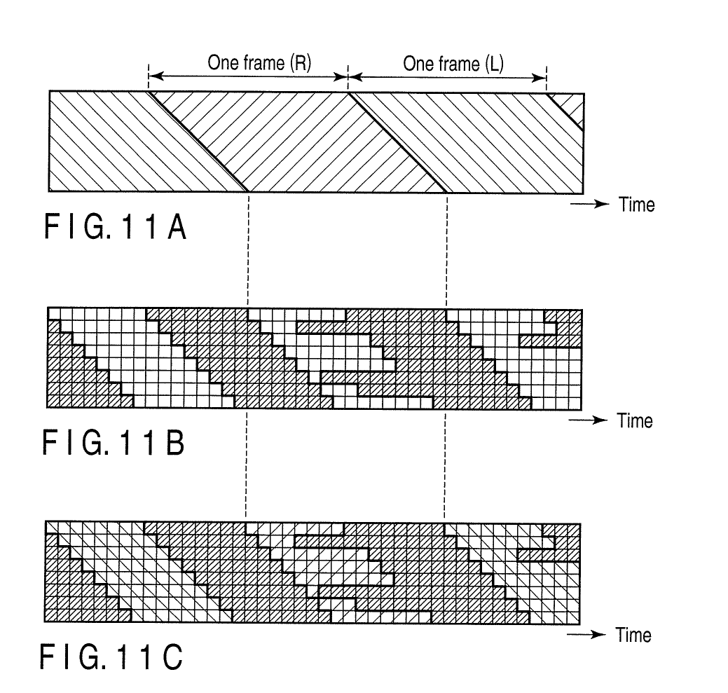

FIGS. 11A to 11C show an image displayed on the liquid-crystal display panel 19 and the lighting state of each light source unit 28 of the backlight 21. In FIGS. 11A to 11C, the ordinate represents the vertical direction of the screen and the abscissa represents time. In the liquid-crystal display panel 19, as an image signal is written into the pixels 25, an image of the pixels is updated horizontal line by horizontal line sequentially from the top to bottom of the screen as shown in FIG. 11A.

Accordingly, in the backlight 21, too, the light source unit 28 in each block 27 is turned on sequentially in synchronization with the output timing of an image on the liquid-crystal display panel 19 as shown in FIG. 11B. Then, as shown in FIG. 11C, the stereoscopic image display apparatus 11 displays an image of the liquid-crystal display panel 19 corresponding to the blocks 27 whose light source units 28 light.

According to the embodiment, the amount of three-dimensional crosstalk can be reduced in the image output of the stereoscopic image display apparatus 11 since the luminance contrast ratio of the image output of the liquid-crystal display panel 19 is made lower in a state where the light source unit 28 is controlled so as to be turned off for a specific time t1 since the start time of each frame and turned on when time t1 has elapsed. In addition, the luminance of the image output of the stereoscopic image display apparatus 11 is corrected by controlling the lighting time of the light source unit 28 by a decrease in the luminance contrast ratio, thereby preventing the deterioration of luminance.

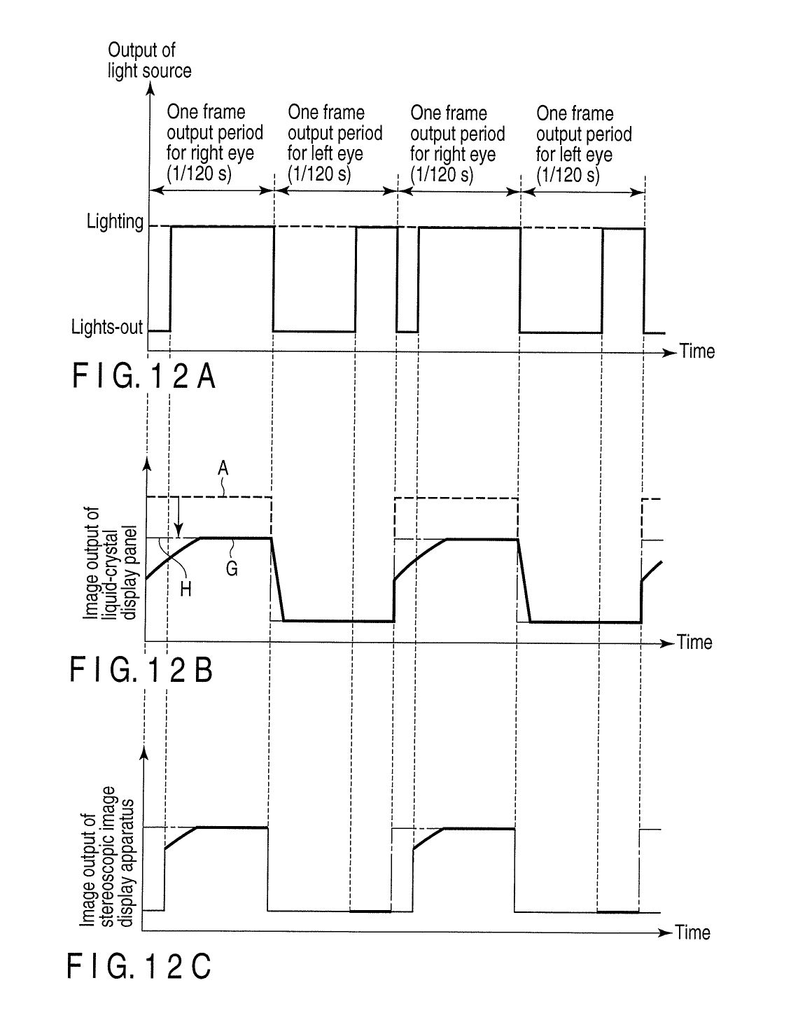

In the embodiment, when the luminance contrast ratio of the image output of the liquid-crystal display panel 19 is decreased, the upper and lower limits of the characteristic shown by dotted line A are both changed. However, in the liquid-crystal display panel 19, the falling part of the image output (luminance response characteristic) might has a steep characteristic close to an ideal one as shown by, for example, solid line G in FIG. 12B. In such a case, the image output of the liquid-crystal display panel 19 is suppressed only at the time of rising as shown by dot-dash line H in FIG. 12B. That is, it is possible to change only the upper limit of the contrast ratio without changing the lower limit.

Conversely, when the rising part of the image output (luminance response characteristic) of the liquid-crystal display panel 19 has a steep characteristic close to an ideal one, the image output of the liquid-crystal display panel 19 is suppressed only at the time of falling. That is, it is possible to change only the lower limit of the contrast ratio without changing the upper limit.

In the explanation, crosstalk in a specific pixel 25 has been reduced by controlling the lighting time of the light source unit 28 which applies light to the specific pixel 25. In the embodiment, the lighting time of the other pixels 25 displayed on the display panel 19 is controlled in a similar manner using local dimming techniques. By this control, the stereoscopic image display apparatus 11 reduces crosstalk throughout the liquid-crystal display panel 19.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image display apparatus comprising:
an input module configured to take in a first image signal and a second image signal having a parallax with respect to the first image signal, a luminance of the second image signal being lower than that of the first image signal;
a luminance processing module configured to decrease the luminance of the first image signal and increase the luminance of the second image signal;
a display panel configured to display the first image signal with decreased luminance and the second image signal with increased luminance;
a light source configured to apply light to the display panel; and
a lighting time control module configured to control the lighting time of the light source so as to make a length of lighting time of the light source longer than a predetermined length of time when the first image signal whose luminance has been decreased is displayed on the display panel, and to make the length of lighting time of the light source shorter than the predetermined length of time when the second image signal whose luminance has been increased is displayed on the display panel.

2. The apparatus of claim 1, wherein the lighting time control module is configured to control the lighting time of the light source based on a difference in luminance between the first and second image signals taken in by the input module.

3. The apparatus of claim 1, wherein the lighting time control module is configured
to control the length of lighting time of the light source so as to correct the decreased luminance of the first image signal when the first image signal with decreased luminance is displayed on the display panel and
to control the length of lighting time of the light source so as to correct the increased luminance of the second image signal when the second image signal with increased luminance is displayed on the display panel.

4. The apparatus of claim 1, wherein the lighting time control module is configured
to make the length of lighting time of the light source longer than the length of time set based on the luminance of the first image signal taken in by the input module when the first image signal with decreased luminance is displayed on the display panel and
to make the length of lighting time of the light source shorter than the length of time set based on the luminance of the second image signal taken in by the input module when the second image signal with increased luminance is displayed on the display panel.

5. The apparatus of claim 1, wherein the luminance processing module is configured to control the luminance of each of the first and second image signals based on a difference in luminance between the first and second image signals taken in by the input module.

6. The apparatus of claim 1, wherein the luminance processing module is configured to control the luminance of either the first or second image signal based on a difference in luminance between the first and second image signals taken in by the input module.

7. The apparatus of claim 1, wherein the display panel comprises a liquid-crystal display panel and the light source comprises an LED.

8. A stereoscopic image display method comprising:
inputting a first image signal and a second image signal having a parallax with respect to the first image signal, a luminance of the second image signal being lower than that of the first image signal;
decreasing the luminance of the first image signal and increasing the luminance of the second image signal;
consecutively displaying on a display panel the first image signal with decreased luminance and the second image signal with increased luminance;
applying light from a light source to the display panel; and
controlling the lighting time of the light source
to make the length of lighting time of the light source longer than a predetermined length of time when the first image signal with decreased luminance is displayed on the display panel and
to make the length of lighting time of the light source shorter than the predetermined length of time when the second image signal with increased luminance is displayed on the display panel.
